(19) United States
(12) Patent Application Publication
(10) Pub. No.: US 2014/0116598 A1
(43) Pub. Date: May 1, 2014

(54) APPARATUS AND METHOD OF LAMINATING ADHESIVE FILM

(71) Applicant: SAMSUNG DISPLAY CO., LTD., Yongin-city (KR)

(72) Inventor: Dong-Sun Lee, Yongin-city (KR)

(73) Assignee: Samsung Display Co., Ltd., Yongin-city (KR)

(21) Appl. No.: 13/857,945

(22) Filed: Apr. 5, 2013

(30) Foreign Application Priority Data
Oct. 26, 2012 (KR) 10-2012-0119733

(51) Int. Cl. B32B 37/10

(52) U.S. Cl. CPC B32B 37/10
USPC 156/60; 156/580

(57) ABSTRACT

An apparatus and a method of laminating an adhesive film are disclosed. In one aspect, an apparatus for laminating an adhesive film includes a stage on which a first substrate, the adhesive film, and a second substrate are sequentially laminated. It also includes a height adjustment member positioned on one lateral portion of the stage to support the second substrate and configured to move in up and down directions of the stage; and a press roller to press the first substrate, the adhesive film and the second substrate on the stage. It also includes a horizontal direction moving unit moving the stage in a relatively horizontal direction to the press roller in a state where the first substrate, the adhesive film, and the second substrate are pressed by the press roller. It further includes a height adjustment unit configured to adjust the height adjustment member.

### CROSS-REFERENCE TO RELATED APPLICATIONS

This application claims priority to and the benefit of Korean Patent Application No. 10-2012-0119733 filed in the Korean Intellectual Property Office on Oct. 26, 2012, the entire contents of which are incorporated herein by reference.

### BACKGROUND

1. Field of the Technology

The described technology relates to an apparatus and a method of laminating an adhesive film.

2. Description of the Related Technology

An organic light emitting diode (OLED) refers to use of ‘a self-light emitting organic material’ emitting light where light is emitted when a current flows through a fluorescent organic compound. The OLED may be driven at a low voltage and manufactured in a thin foil type. It also has a wide viewing angle and a high response speed. Therefore, it may become a next generation display apparatus to replace the current light crystal display (LCD) in many display applications.

OLED technology may be classified into a passive type PMOLED and an active type AMOLED according to driving technique. Particularly, an AMOLED is a self-light emitting type display, and its merits include high response speed, natual color sense, and low power consumption. Further, if the AMOLED is applied to a film or the like instead of a glass substrate, a flexible display can be produced.

### SUMMARY OF CERTAIN INVENTIVE ASPECTS

One inventive aspect is an apparatus and a method of laminating an adhesive film between a first substrate and a second substrate.

Another aspect is an apparatus for laminating an adhesive film, including: a stage on which a first substrate, the adhesive film, and a second substrate are sequentially laminated; a height adjustment member positioned on one side portion of the stage to support one portion of a lower surface of the second substrate and be movable in up and down directions of the stage; a press roller positioned on an upper side of the second substrate to press the first substrate, the adhesive film and the second substrate provided on the stage; a horizontal direction moving unit moving the stage in a relatively horizontal direction to the press roller in a state where the first substrate, the adhesive film, and the second substrate are pressed by the press roller; and a height adjustment unit for adjusting a height of the height adjustment member while the stage is moved in the relatively horizontal direction to the press roller.

In some embodiments, the height of the height adjustment member may be controlled so that while one portion of the lower surface of the second substrate is moved to the press roller, one portion of the lower surface of the second substrate is maintained at a state where the side is inclined at a predetermined angle to the horizontal direction or has a lower angle.

In some embodiments, the height adjustment unit may include a rolling roller installed on a lower portion of the height adjustment member; and an inclination guide having an inclination surface that is downwardly inclined in a moving direction of the state so as to guide movement of the rolling roller.

In other embodiments, the inclination surface of the inclination guide may have an angle of 0 to 10° to the horizontal direction.

In some embodiments, the apparatus may include: a press cylinder for moving the press roller in up and down directions.

In some embodiments, the horizontal direction moving unit may include a ball screw installed at a lower side of the stage to be combined with the stage; and a driver for rotating the ball screw.

In some embodiments, the driver may be a rotation handle or a driving motor.

In other embodiments, the apparatus may further include: an alignment guide positioned on another side portion of the stage to guide alignment of one corner of each of the first substrate, the adhesive film, and the second substrate.

In some embodiments, the alignment guide may have a protruding portion that is higher than the stage, and a protruding height of the protruding portion may be larger than a thickness of the first substrate.

Meanwhile, the height adjustment unit may include a cam member supporting the height adjustment member at a lower side of the height adjustment member.

Meanwhile, the height adjustment unit may include a ball screw supporting the height adjustment member at the lower side of the height adjustment member.

In some embodiments, the first substrate and the second substrate may be made of a glass material.

Another aspect is a method of laminating an adhesive film between a first substrate and a second substrate by using the aforementioned apparatus for laminating the adhesive film, including: (a) positioning the first substrate, the adhesive film, and the second substrate on a stage; (b) supporting an end of the second substrate so that the end of the second substrate is higher than another end of the second substrate; (c) pressing the first substrate, the adhesive film, and the second substrate by using a press roller while the stage is relatively moved in a direction from another end of the second substrate to the end of the second substrate; (d) adjusting a height of the end of the second substrate so that while the stage is relatively moved to the press roller, the height of the end of the second substrate is identically maintained or gradually reduced; and (e) finishing relative movement of the stage after the second substrate is pressed on the first substrate by the adhesive film by providing the press roller to an upper surface of the second substrate.

In some embodiments, in step (e), the height of the end of the second substrate may be the same as the height of another end of the second substrate.

According to various embodiments of the described technology, an adhesive film may be laminated between a first substrate and a second substrate without occurrence of bubbles by using an apparatus for laminating the adhesive film.

### BRIEF DESCRIPTION OF THE DRAWINGS

FIG. 1 is a cross-sectional view of a display panel where an adhesive film is laminated between Ltps glass and Encap glass.

FIG. 2 is a schematic diagram of an apparatus for laminating an adhesive film according to an embodiment.

FIG. 3 is a side view of the apparatus for laminating the adhesive film according to an embodiment.

FIG. 4 is a flowchart of a method of laminating an adhesive film by using the apparatus for laminating the adhesive film according to an embodiment.

FIG. 5 is a view of a state where a first substrate, an adhesive film, and a second substrate are positioned on a stage in the course of laminating the adhesive film by using the apparatus for laminating the adhesive film according to anembodiment.

FIG. 6 is a view of a state where relative movement of the stage is finished in the course of laminating the adhesive film by using the apparatus for laminating the adhesive film according to an embodiment.

FIG. 7 is a view schematically illustrating the course of laminating an adhesive film by using an apparatus for laminating the adhesive film according to anotherembodiment.

FIG. 8 is a view schematically illustrating the course of laminating an adhesive film by using an apparatus for laminating the adhesive film according to another embodiment.

### DETAILED DESCRIPTION OF CERTAIN INVENTIVE EMBODIMENTS

The known AMOLED has a structure where N₂ gas is injected between Ltps glass and Encap glass that are display panels and a space between the Ltps glass and the Encap glass is sealed. As described above, where N₂ gas is injected, oxidation of a pixel occurs over time due to separation of a cell seal and generation of fine cracks when external impact is applied.

Meanwhile, separation of the cell seal and breaking of glass occur when external impact is applied by injecting N₂ gas between the Ltps glass and the Encap glass that are the display panels. In addition, in the case where the panel is enlarged, pixel inferiority occurs due to drooping of glass.

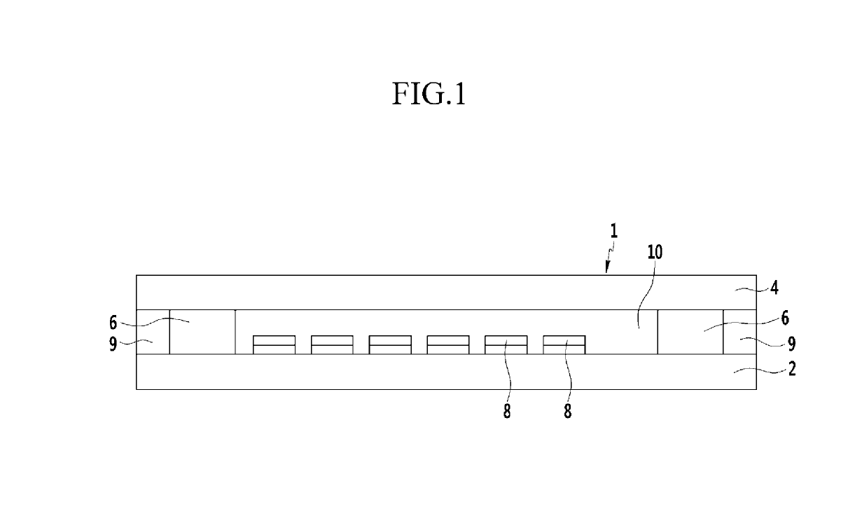

In order to avoid the aforementioned problems, as shown in FIG. 1, a technology has been developed where an adhesive film 10 is laminated between Ltps glass (first substrate: 2) and Encap glass (second substrate: 4) to fill a space between Ltps glass (first substrate) and Encap glass (second substrate), thus rendering loss of imaging quality of the display panel 1 over time, and improving optical characteristics and strength of the panel.

In this case, referring to FIG. 1, a sealing portion 6 and a reinforcing portion 9 are positioned at both ends of the adhesive film between Ltps glass (first substrate: 2) and Encap glass (second substrate: 4) of the display panel, and an organic EL element is formed on the Ltps glass (first substrate: 2).

An apparatus for laminating an adhesive film between Ltps glass and Encap glass needs to be developed in order to manufacture the AMOLED panel having the aforementioned structure.

Hereinafter, embodiments will be described more fully with reference to the accompanying drawings, in which embodiments are shown. As those skilled in the art would realize, the described embodiments may be modified in various different ways, all without departing from the spirit or scope of the described technology. The drawings and description are to be regarded as illustrative in nature and not restrictive. The same reference numerals designate the same or like elements throughout the specification.

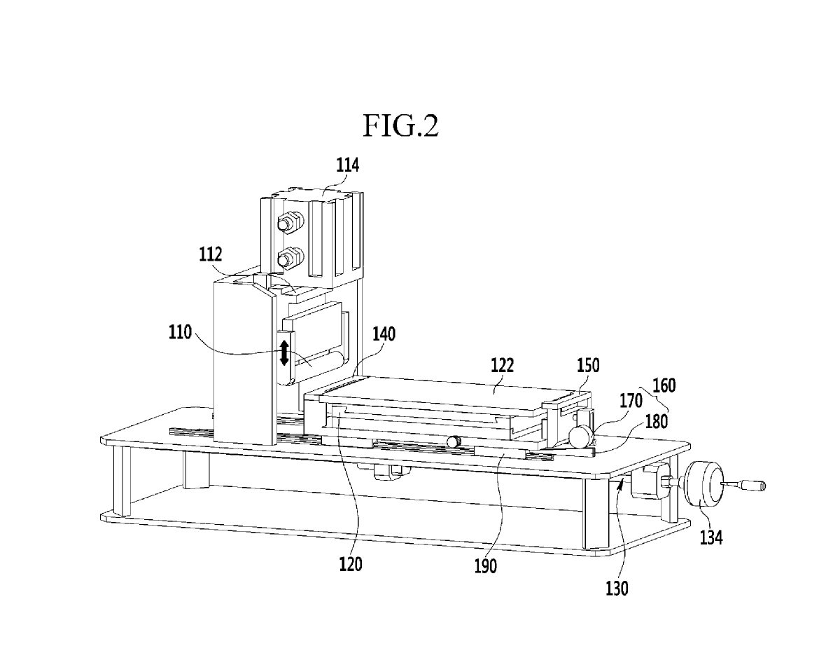

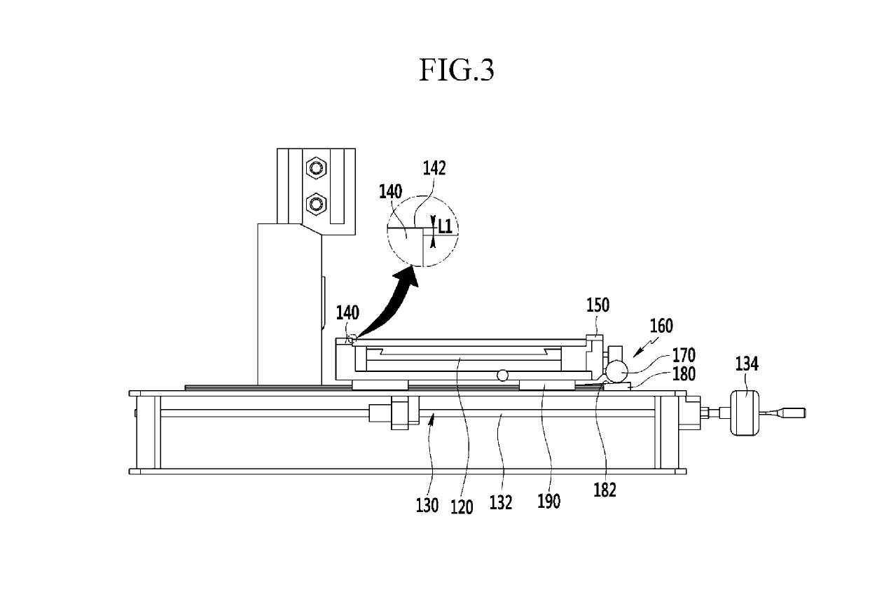

FIG. 2 is a schematic diagram of an apparatus for laminating an adhesive film according to an embodiment. FIG. 3 is a side view of the apparatus for laminating the adhesive film according to an embodiment.

Referring to FIGS. 2 and 3, an apparatus 100 for laminating the adhesive film according to an embodiment may include a stage 120, a height adjustment member 150, a press roller 110, a horizontal direction moving unit 130, and a height adjustment unit 160.

The apparatus 100 for laminating the adhesive film according to an embodiment is an apparatus for adhering a first substrate 2 and a second substrate 4 by an adhesive film 10 by positioning the adhesive film 10 between the first substrate 2 and the second substrate 4 forming a display panel 1 and pressing the first substrate 2 and the second substrate 4 each other. In this case, according to an embodiment, the first substrate 2 may be Ltps glass and the second substrate 4 may be Encap glass, but in the apparatus for laminating the adhesive film, types of the first substrate and the second substrate laminating the adhesive film are not limited thereto.

For example, the stage 120 of the apparatus 100 for laminating the adhesive film according to an embodiment is formed of a plate type member having a rectangular shape, in which the first substrate 2, the adhesive film 10, and the second substrate 4 are laminated on an upper surface thereof

In some embodiments, the upper surface 122 of the stage 120, on which the first substrate 2, the adhesive film 10, and the second substrate 4 are laminated, is horizontally arranged.

In addition, the upper surface 122 of the stage 120, on which the first substrate 2 is positioned, may be formed to have a width that is larger than that of the first substrate 2, and the second substrate 4 may be formed to have a length that is larger than that of the first substrate 2 in left and right directions.

A press roller 110 is positioned on an upper portion of the stage 120. The press roller 110 is formed to be movable in up and down directions along an up and down direction guide 112 by a press cylinder 114. The press roller 110 is formed to combine the first substrate 2 and the second substrate 4 with each other by the adhesive film 10 by pressing the first substrate 2, the adhesive film 10, and the second substrate 4 positioned on the upper surface of the stage 120 in a state where the press roller is moved in a down direction.

Meanwhile, according to an embodiment, the stage 120 is combined with the horizontal direction moving unit 130 so that the press roller 110 is relatively moved from an end of the second substrate 4 to another end thereof.

In this case, according to an embodiment, the horizontal direction moving unit 130 includes a ball screw 132 and a driver extending in a movement direction of the stage 120 on the lower portion of the stage 120.

In this case, referring to FIG. 2, the driver according to an embodiment may be a rotation handle 134 combined with an end of a rotation shaft of the ball screw 132. Accordingly, if the rotation handle 134 is moved by a worker, the stage 120 may be moved in left and right directions to the press roller 110 in view of FIG. 2. In this case, the driver for rotating the ball screw 132 may include a known driving apparatus that may be electrically controlled like a driving motor.

Meanwhile, according to an embodiment, an alignment guide 140 is installed on a left end of the stage 120 in view of FIG. 3. In this case, the alignment guide 140 may be integrally formed with the stage 120 or formed in a separation form to the stage 120.

According to an embodiment, the alignment guide 140 has a protruding portion 142 that is higher than the upper surface of the stage 120.

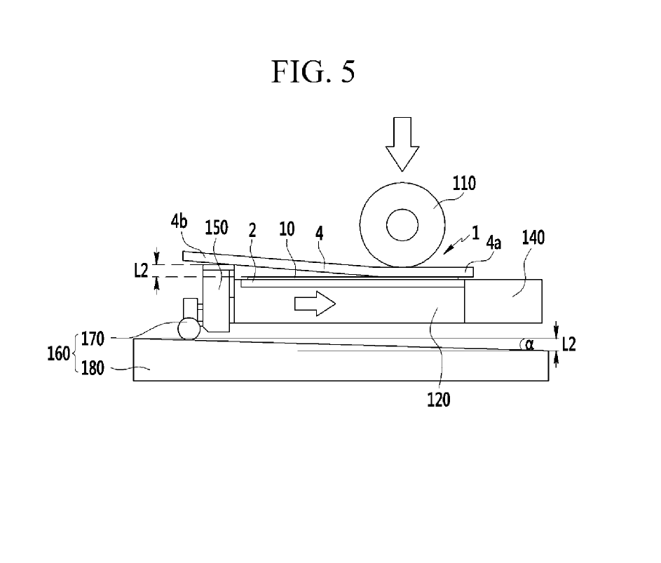

In this case, the protruding height of the protruding portion 142 may be larger than a thickness L1 of the first substrate 2 positioned on the upper surface of the stage 120. Accordingly, corners of the first substrate 2, the adhesive film 10, and the second substrate 4 may be aligned in a state where one corner of the first substrate 2 is in contact with the protruding portion of the alignment guide 140, and as described above, the press roller 110 may be moved in a direction from the left end of the upper surface of the second substrate 4 to the right end thereof in a state where the first substrate 2, the adhesive film 10, and the second substrate 4 are aligned in view of FIG. 5, thus adhering the first substrate 2 and the second substrate 4 to each other.

Meanwhile, according to an embodiment, a height adjustment member 150 is installed on a right end of the stage 120 in view of FIG. 3.

The height adjustment member 150 is formed to support one portion of the lower surface of the second substrate 4 and be moved in up and down directions in a state where the second substrate 4 is positioned on the stage 120, thus adjusting the height of the right end of the second substrate 4.

For this purpose, the upper surface of the height adjustment member 150 may have a flat plate form on which the second substrate 4 is positioned, and a guide (not illustrated) may be installed on a lateral surface of the right end of the stage 120 to move the height adjustment member 150 in up and down directions.

In this case, according to an embodiment, the height adjustment unit 160 is installed on the lower portion of the height adjustment member 150 in order to adjust the height of the height adjustment member 150.

In this case, according to an embodiment, the height adjustment unit 160 may include a rolling roller 170 and an inclination guide 180 formed so that the rolling roller 170 is movable.

The rolling roller 170 is rotatably formed on the lower portion of the height adjustment member 150.

The inclination guide 180 has a flat or curved inclination surface 182 inclined so that a right end is high and a left end is low in view of FIGS. 2 and 3.

In this case, the inclination surface 182 may be formed to have an angle (α of FIG. 5) between 0° to 10° to the horizontal direction, but the angle of the inclination surface 182 is not limited thereto.

Accordingly, while the rolling roller 170 is moved along the inclination guide 180, the height adjustment member 150 may be formed to have a height so that one portion of the lower surface of the second substrate 4 is maintained at an inclination state at a predetermined angle to a horizontal direction or has a lower angle.

Hereinafter, the method of laminating the adhesive film by using the apparatus for laminating the adhesive film according to an embodiment will be described with reference to the other drawings.

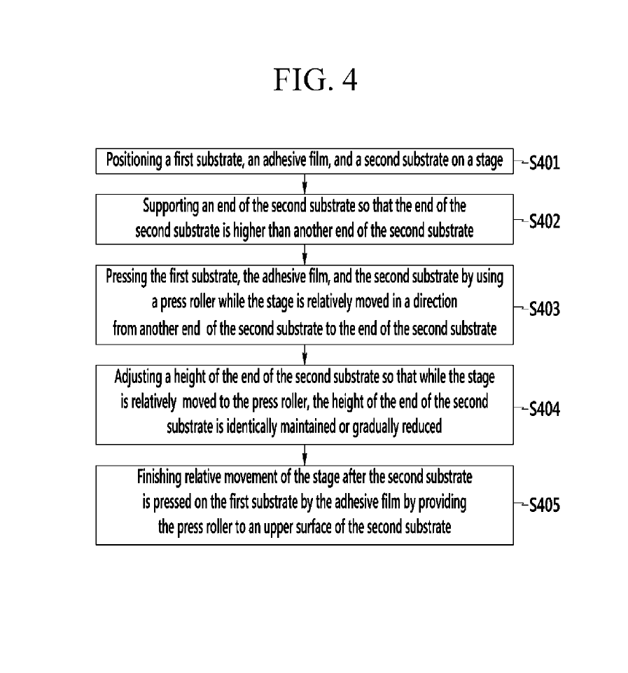

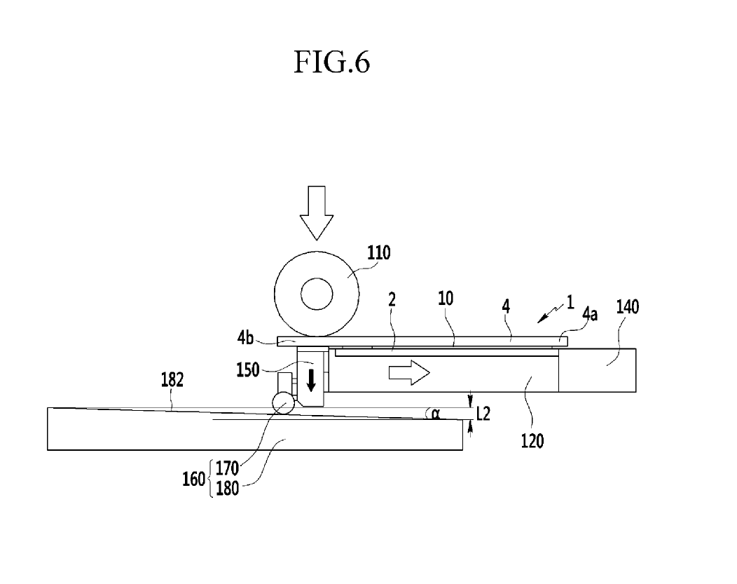

FIG. 4 is a flowchart of a method of laminating an adhesive film by using the apparatus for laminating the adhesive film according to an embodiment. FIG. 5 is a view of a state where a first substrate, an adhesive film, and a second substrate are positioned on a stage in the course of laminating the adhesive film by using the apparatus for laminating the adhesive film according to an embodiment. FIG. 6 is a view of a state where relative movement of the stage is finished in the course of laminating the adhesive film by using the apparatus for laminating the adhesive film according to an embodiment.

Referring to FIGS. 4 and 5, in the method of laminating the adhesive film by using the apparatus for laminating the adhesive film according to an embodiment, the first substrate 2, the adhesive film 10, and the second substrate 4 are first positioned on the stage, as described in S401 of FIG. 4.

In this case, as shown in FIG. 5, one corner of the left side of the first substrate 2 is positioned on the stage 120 to match the protruding portion of the alignment guide 140, the adhesive film 10 is positioned on the first substrate, and the second substrate 4 is positioned on the adhesive film 10, as described in S402 of FIG. 4.

In this case, the left end of the second substrate is supported by the height adjustment member 150 so that an end of the second substrate 4, that is, the height of the right end is larger than the height of the left end of the second substrate 4. In this case, when the height of the left end of the second substrate 4 is compared to the height of the right end of the second substrate 4, the height of the left end is larger than the height of the right end by L2.

Thereafter, while the stage 120 is relatively moved in a direction from the left end of the second substrate 4 to the right end of the second substrate 4, the first substrate 2, the adhesive film 10, and the second substrate 4 are pressed by using the press roller 110 (S403).

In this case, the stage 120 may be moved by rotating the rotation handle 134 connected to the ball screw 132 at the lower side of the stage 120, but in the case where the ball screw 132 is connected to the driving motor, there may be provided the constitution where rotation of the ball screw is electrically controlled.

Meanwhile, in one embodiment, the position of the press roller is fixed in left and right directions, and the stage is moved in a press roller direction, but the apparatus may be constituted so that the press roller is moved in left and right directions in a state where the position of the stage is fixed, and the press roller may be relatively moved to the stage.

In this case, while the stage 120 is relatively moved to the press roller 110, the height of the left end of the second substrate 4 is adjusted so that the height of the left end of the second substrate 4 is identically maintained or gradually reduced, as described in S404 of FIG. 4.

In this case, the height of the left end of the second substrate 4 is adjusted by the height adjustment unit 160 positioned at the lower side of the height adjustment member 150.

To be more specific, referring to FIGS. 5 and 6, the lowest height of the right end of the second substrate 4 supported by the height adjustment member 150 is the same as the height of the left end of the second substrate, and the highest height thereof is larger than the height of the left end of the second substrate 4 by a predetermined height difference L2.

Therefore, in the apparatus 100 for laminating the adhesive film according to one embodiment, the height of the left end of the second substrate 4 is maintained to be larger than the height of the right end of the second substrate 4 in the course of pressing the first substrate 2 and the second substrate 4 while the rolling roller 170 is moved on the second substrate 4 in a state where the second substrate 4 is positioned on the first substrate 2 and the adhesive film 10, and the press roller is moved along the inclination surface in a down direction as the rolling roller 170 is relatively moved in a direction from the right end of the second substrate 4 to the left end thereof, and thus the height of the left end of the second substrate 4 is reduced.

As described above, the right end of the second substrate 4 is set to be higher than the left end of the second substrate 4 having the lowest height while the second substrate 4 is adhered to the first substrate 2 by the adhesive film 10, and the right end of the second substrate 4 is maintained to be lifted while the press roller 110 is moved, such that adhesion between the adhesive film 10 and the lower surface of the second substrate 4 and pressing between the first substrate 2 and the second substrate are gradually performed from the left end of the second substrate 4 to the right end thereof in the course of pressing the second substrate 4 while being adhered to the adhesive film.

Accordingly, an air layer may not be interposed between the lower surface of the second substrate 4 and the adhesive film 10 and between the upper surface of the first substrate 2 and the adhesive film 10, and the first substrate 2, the adhesive film 10, and the second substrate 4 may be firmly adhered.

As described above, if relative movement of the stage 120 is finished after the second substrate 4 is pressed by providing the press roller 110 to the upper surface of the second substrate 4 to press the second substrate 4 on the first substrate 2 by the adhesive film 10, adhesion of the first substrate 2 and the second substrate 4 is finished, as described in S405 of FIG. 4.

As described above, when the press roller 110 approaches the left end of the second substrate 4 and is moved to a point at which pressing of the second substrate 4 is finished, as shown in FIG. 6, the height of the left end of the second substrate 4 and the height of the right end of the second substrate 4 may be the same as each other.

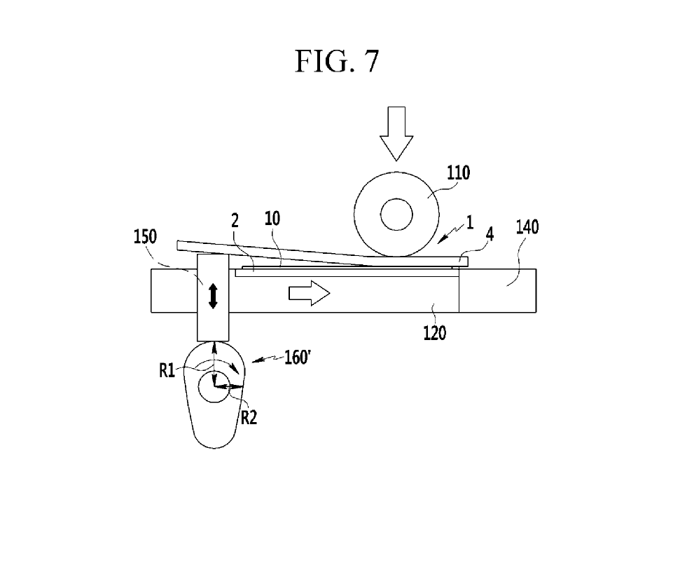

FIG. 7 is a view schematically illustrating the course of laminating an adhesive film by using an apparatus for laminating the adhesive film according to another embodiment. In the description of the apparatus for laminating the adhesive film according to another embodiment, the detailed description of the same constitution as the apparatus for laminating the adhesive film according to the aforementioned embodiment will be omitted, and the constitution that is different from that of the aforementioned embodiment will be mainly described.

Referring to FIG. 7, the apparatus for laminating the adhesive film according to another embodiment may include a cam member 270 as a height adjustment unit 160″. The height adjustment member 150 is formed on the upper surface of the cam member 270 to be movable in up and down directions, and, as described above, in the case where the height of the height adjustment member 150 is adjusted by using the cam member 270, the height of the height adjustment member 150 may be adjusted by operation of rotation of the cam member 270 without using the rolling roller and the inclination guide unlike the aforementioned embodiment.

In this case, the cam member 270 may adjust the height difference of the height adjustment member 150 by allowing R1-R2 to have a length of L2 when the radius of the farthest distance from the rotation shaft is R1 and the radius of the closest distance from the rotation shaft is R2.

The cam member 270 may be rotatably controlled by using a driving source such as a driving motor, which is not illustrated in the drawings.

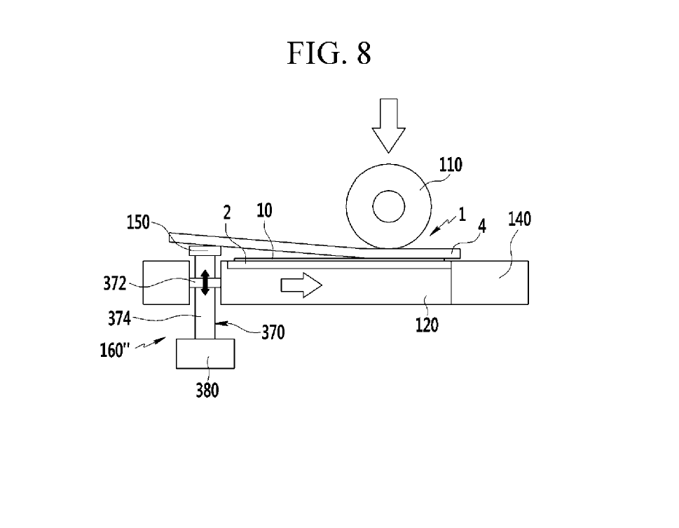

FIG. 8 is a view schematically illustrating the course of laminating an adhesive film by using an apparatus for laminating the adhesive film according to another embodiment. In the description of the apparatus for laminating the adhesive film according to another embodiment, the detailed description of the same constitution as the apparatus for laminating the adhesive film according to the aforementioned embodiment will be omitted, and the constitution that is different from that of the aforementioned embodiment will be mainly described.

Referring to FIG. 8, the apparatus for laminating the adhesive film according to another embodiment may include a ball screw 370 as a height adjustment unit 160″. The ball screw 370 may be rotatably supported on a support fixture 380.

In this case, according to another embodiment, a screw portion 372 of the ball screw 370 is fixed to a lateral portion of the stage 120, and may be formed to be movable in up and down directions by rotation of the rotation shaft 374.

Accordingly, the height adjustment member 150 installed on the upper end of the rotation shaft 374 may be moved in up and down directions according to rotation of the rotation shaft 374 to adjust the height of the right end of the second substrate.

In some embodiments, the apparatus for laminating the adhesive film, which is constituted so that the height of the height adjustment member is adjusted by using the inclination guide, the cam member, and the ball screw, is described, but the height of the height adjustment member may be adjusted by using the height adjustment unit having various known constitutions not described herein.

In the apparatus for laminating the adhesive film according to various embodiments, air layers or bubbles are not formed between the substrates by pressing the second substrate while the height of an end of the second substrate is adjusted in the course of laminating the adhesive film between the first substrate and the second substrate, and thus, the first substrate and the second substrate may be firmly adhered by the adhesive film.

The above embodiments are presented for illustrative purposes only, and are not intended to define meanings or limit the scope of the present invention as set forth in the following claims. Those skilled in the art will understand that various modifications and equivalent embodiments of the present invention are possible without departing from the spirit and scope of the present invention defined by the appended claims.

What is claimed is:

1. An apparatus for laminating an adhesive film, comprising:
a stage on which a first substrate, the adhesive film, and a second substrate are sequentially laminated;
a height adjustment member positioned on one lateral portion of the stage to support one portion of a lower surface of the second substrate and configured to move in up and down directions of the stage;
a press roller positioned on an upper side of the second substrate to press the first substrate, the adhesive film and the second substrate provided on the stage;
a horizontal direction moving unit configured to move the stage in a relatively horizontal direction to the press roller in a state where the first substrate, the adhesive film, and the second substrate are pressed by the press roller; and
a height adjustment unit configured to adjust a height of the height adjustment member while the stage is moved in the relatively horizontal direction to the press roller.

2. The apparatus for laminating an adhesive film of claim 1, wherein the height of the height adjustment member is configured to control so that while one portion of the lower surface of the second substrate is moved to the press roller, one portion of the lower surface of the second substrate is maintained at a state where the portion is inclined at a same or lower angle than a predetermined angle to the horizontal direction.

3. The apparatus for laminating an adhesive film of claim 1, wherein the height adjustment unit comprises:
a rolling roller installed on a lower portion of the height adjustment member; and
an inclination guide having an inclination surface that is downwardly inclined in a moving direction of the state so as to guide movement of the rolling roller.

4. The apparatus for laminating an adhesive film of claim 3, wherein the inclination surface of the inclination guide has an angle of 0 to 10° to the horizontal direction.

5. The apparatus for laminating an adhesive film of claim 1, further comprising a press cylinder configured to move the press roller in up and down directions.

6. The apparatus for laminating an adhesive film of claim 1, wherein the horizontal direction moving unit comprises:
a ball screw installed at a lower side of the stage to be combined with the stage; and
a driver for rotating the ball screw.

7. The apparatus for laminating an adhesive film of claim 6, wherein the driver is a rotation handle or a driving motor combined with a rotation shaft of the ball screw.

8. The apparatus for laminating an adhesive film of claim 1, further comprising an alignment guide positioned on another side portion of the stage to guide alignment of one corner of each of the first substrate, the adhesive film, and the second substrate.

9. The apparatus for laminating an adhesive film of claim 8, wherein the alignment guide has a protruding portion that is higher than the stage, and a protruding height of the protruding portion is larger than a thickness of the first substrate.

10. The apparatus for laminating an adhesive film of claim 1, wherein the height adjustment unit includes a cam member supporting the height adjustment member at a lower side of the height adjustment member.

11. The apparatus for laminating an adhesive film of claim 1, wherein the height adjustment unit includes a ball screw supporting the height adjustment member at the lower side of the height adjustment member.

12. The apparatus for laminating an adhesive film of claim 1, wherein the first substrate and the second substrate are made of a glass material.

13. A method of laminating an adhesive film, comprising:
positioning a first substrate, an adhesive film, and a second substrate on a stage;
supporting an end of the second substrate so that the end of the second substrate is higher than another end of the second substrate;
pressing the first substrate, the adhesive film, and the second substrate by using a press roller while the stage is relatively moved in a direction from another end of the second substrate to the end of the second substrate;
adjusting a height of the end of the second substrate so that while the stage is relatively moved to the press roller, the height of the end of the second substrate is identically maintained or gradually reduced; and
finishing relative movement of the stage after the second substrate is pressed on the first substrate by the adhesive film by providing the press roller to an upper surface of the second substrate.

14. The method of laminating an adhesive film of claim 13, wherein the height of the end of the second substrate is the same as the height of another end of the second substrate.
